(19) United States
(12) Patent Application Publication
(10) Pub. No.: US 2010/0087319 A1
(43) Pub. Date: Apr. 8, 2010

(54) Agrochemical Preparations

(75) Inventors: Hans-Georg Mainx, Leichlingen (DE); Ansgar Behler, Bottrop (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/596,929

(22) PCT Filed: Apr. 12, 2008
(86) PCT No.: PCT/EP08/02911

§ 371 Date: Oct. 21, 2009

(30) Foreign Application Priority Data
Apr. 21, 2007 (DE) 10 2007 018 983.6

(51) Int. Cl. A01N 37/00; A01N 37/06

(52) U.S. Cl. 504/142; 514/529; 514/547

(57) ABSTRACT

The invention relates to agrochemical preparations containing (a) active ingredients and (b) esters of hydroxycarboxylic acids.

### FIELD OF THE INVENTION

The invention occurs in the field of agrochemicals and relates to novel preparations with a content of hydroxycarboxylic acid esters as emulsifiers or adjuvants.

### STATE OF THE ART

Commercial plant protection products can be formulated in very different ways. Generally, concentrates are sold and are emulsified or dispersed in water by the customer to a use level of 0.1 to 5% by weight and then sprayed onto the plants. The active compounds present in these formulations can either be present in dissolved form (EC or EW formulations), be suspended or emulsified (SC or SE formulations) or be used as solids (WP, WDG or EG formulations or wettable powders). In recent years, apart from the demand for especially efficient active compounds, an additional performance criterion which has gained acceptance in the market is that of the high toxicological and ecological compatibility of all formulation constituents, in particular even the surfactant constituents (“green products”).

The object of the present invention has accordingly consisted in making available novel agrochemical preparations which comprise, in addition to the well-known active compounds, water-soluble emulsifiers which are simultaneously characterized in that they allow the stable incorporation of even active compounds which are otherwise difficult to emulsify or disperse, in the sense of adjuvants which enhance properties of the active compounds and furthermore have a sufficiently high ecotoxicological compatibility.

### DESCRIPTION OF THE INVENTION

A subject-matter of the invention are agrochemical preparations, comprising
(a) active compounds and
(b) esters of hydroxycarboxylic acids.

It has been found, surprisingly, that esters of hydroxycarboxylic acids, especially esters based on citric acid, comply with the complex profile of requirements in an excellent way. The esters are oil-soluble, exhibit a high emulsifying and dispersing performance and also allow the stable incorporation of active compounds which otherwise can be emulsified or dispersed only by introducing high shear forces and, in many cases, enhance, by improving the penetration, the performance of these active compounds. In addition, they are readily and completely biodegradable and, in many cases, are free of labeling requirements in accordance with point 15 of the EU safety datasheet.

### Active Compounds

Suitable active compounds within the meaning of the present invention are, on the one hand, (a1) pesticides, i.e. herbicides, insecticides and fungicides, and, on the other hand, (a2) fatty substances and hydrocarbons, including mixtures of the groups mentioned. If here a distinction is made between two groups of active compounds, then, in view of the fact that fatty substances and hydrocarbons are suitable not only as plant protection products but also represent conventional carrier oils or solvents for the first-mentioned group of active compounds, a preferred embodiment of the present invention accordingly consists in using mixtures of the groups (a1) and (a2). Individual active compound groups are explained more fully below:

### Herbicides, Fungicides and Insecticides

The pesticides, a generic term for herbicides, fungicides and insecticides, which can also be present in agrochemical formulations, are preferably oil-soluble substances. Typical examples of suitable fungicides are azoxystrobin, benalaxyl, carbendazim, chlorothalonil, copper, cymoxanil, cyproconazole, difenoconazole, dinocap, epoxiconazole, fluazinam, flusilazole, flutriafol, folpel, fosetyl-aluminum, kresoxim-methyl, hexaconazole, mancozeb, metalaxyl, metconazole, myclobutanil, ofurace, fentin hydroxide, prochloraz, pyrimethanil, sulfur, tebuconazole, and tetraconazole, and also the mixtures thereof. Use may be made, as herbicides, of alachlor, aclonifen, acetochlor, amidosulfuron, aminotriazole, atrazine, bentazon, bifenox, bromoxynil octanoate, bromoxynil, clethodim, clodinafop-propargyl, chloridazon, chlorsulfuron, chlortoluron, clomazone, cycloxydim, desmedipham, dicamba, diclofop-methyl, diurea, diflufenicanil, dimethenamid, ethofumesate, fluazifop, fluazifop-P-butyl, fluorochloridone, fluoroxypyr, glufosinate, glyphosate, haloxyfop-P, ioxynil octanoate, isoproturon, isoxaben, metamitron, metazachlor, metalochlor, metsulfuron-methyl, nicosulfuron, norflurazon, oryzalin, oxadiazon, oxyfluorfen, paraquat, pendimethalin, phenmedipham, fenoxaprop-P-ethyl, propaquizafop, prosulfocarb, quizalofop, sulcotrione, sulfosate, terbuthylazine, triasulfuron, triclopyr, trifluralin, and triflusulfuron-methyl, individually or in a mixture. Finally, suitable insecticides are bifenthrin, carbofuran, carbosulfan, chlorpyrifos-methyl, chlorpyrifos-ethyl, beta-cyfluthrin, lambda-cyhalothrin, cyhexatin, cypermethrin, dicofol, endosulfan, tau-fluvalinate, alpha-cypermethrin, delta-methrin, fenbutatin oxide, pirimicarb, terbufos and tebufenpyrad, and also mixtures thereof.

Furthermore, glyphosate can also be used as active compound. Glyphosate is N-(phosphonomethyl)glycine, C₃H₈NO₅P, MW 169.07, melting point 200° C., LD₅₀ (rat oral) 4320 mg/kg (WHO), a nonselective systemic leaf herbicide, which is preferably used in the form of its isopropylamine salt for the total and semitotal control of weeds, including grass weeds and including deep rooted perennial species, on all arable crops, in fruit growing and in viticulture. The structure is as follows:

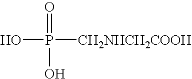

Glyphosate is understood to mean all glyphosate derivatives known to the person skilled in the art, thus, preferably, the mono- or diethanolamine salts thereof. Furthermore, sodium or potassium is possible as cation. The glyphosate isopropylamine salt is particularly important. Furthermore, use may also be made of any mixture of these compounds in the context of the use according to the invention. Since glyphosate exhibits only a low solubility in oils, this active compound is preferably used with other components as tank mix adjuvant.

### Fatty Substances and Hydrocarbons

As already explained above, fatty substances and hydrocarbons, under certain conditions, are also active compounds since they protect the plants from damage. First and foremost, typical carrier oils or solvents are concerned. The number of the possible compounds is also correspondingly high, the choice of which is critical only inasmuch that they satisfy the toxicological and ecological regulations for use in the countryside. Natural fats and oils or synthetic triglycerides, including in particular rapeseed oil and sunflower oil, are preferred. It is also possible to use the alkyl esters, especially the methyl esters, in place of the glycerides. Partial glycerides, fatty acids and fatty alcohols and also fatty amines and fatty amides, within the range of number of carbon atoms typical for fatty substances, thus from 6 to 22 carbon atoms, are likewise suitable. For the hydrocarbons, mention may especially be made of mineral oils, including white mineral oils, alkylaromatic compounds and the well-known mixture Solvesso® 100 (Exxon).

### Hydroxycarboxylic Acid Esters

Esters of hydroxycarboxylic acids are well-known compounds which can be prepared according to the appropriate processes of preparative organic chemistry. Usually, the synthesis is carried out by reacting the hydroxycarboxylic acids with the alcoholic components in the presence of acid catalysts, one component being present in excess and the water of condensation being continuously removed from the reaction equilibrium. In principle, all carboxylic acids substituted by a hydroxyl group are suitable as starting compounds. However, preference is given to lactic acid, malic acid, tartaric acid and in particular citric acid. Particular preference is given to esters of citric acid with
(b1) partial glycerides,
(b2) polyglycol ethers,
(b3) polyglycol esters or
(b4) ring-opening products of α-olefin epoxides,
   it being possible for the esters to be present as full or partial esters. Usually, use is made of industrial mixtures exhibiting a degree of substitution in the range from 1 to 2. Various types of suitable citric acid esters are described more fully below:
   Esters of Citric Acid with Partial Glycerides

Esters of citric acid with partial glycerides (b1), thus mono- or diglycerides or the industrial mixtures thereof, which still have a free hydroxyl group, preferably agree with the formula (I),

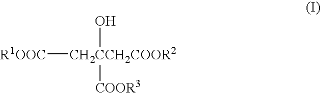

in which R¹ is a —CH₂—CH(OR⁴)CH₂OR⁵ group, R² and R³ are, independently of one another, R⁴ or hydrogen, R⁴ is an acyl radical having from 6 to 22, preferably from 12 to 18, carbon atoms and 0 or from 1 to 3 double bonds and R⁵ is R⁴ or hydrogen. Preferably, the partial glycerides derive from fatty acids with from 12 to 18 carbon atoms, especially industrial coconut oil and palm oil fatty acids. Typical examples are the commercial products Lamegin® ZE 306, Lamegin® ZE 609 and Lamegin® ZE 618 (Cognis Deutschland GmbH & Co. KG).
Esters of Citric Acid with Polyglycol Ethers

Esters of citric acid with polyglycol ethers (b2), thus addition products of alkylene oxides with aliphatic alcohols, which still have a free hydroxyl group on the end of the polyether chain, preferably agree with formula (II),

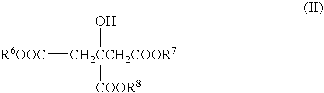

in which R⁶ is an (EO)ₙ₁(PO)ₘ₁(EO)ₚ₁R⁹ group, R⁷ and R⁸ are, independently of one another, R⁶ or hydrogen, R⁹ is an alkyl or alkenyl radical having from 6 to 22, preferably from 12 to 18, carbon atoms, EO or PO is an ethylene oxide or propylene oxide unit and the numbers n1, m1 and p1 are, independently, numbers from 1 to 100, preferably from 2 to 10, the sum (n1+m1+p1) having to be other than 0. Use is preferably made, for the esterification, of addition products of 1 to 10 mol of ethylene oxide and 0 to 2 mol of propylene oxide, it being possible for the distribution to be random or blockwise, with industrial coconut oil fatty alcohols or tallow fatty alcohols. Particular preference is given to the commercial product Plantapon® LC7 (Cognis Deutschland GmbH & Co. KG), which is a mono/diester of citric acid with C_{12/14} coconut oil alcohol+7 EO.
Esters of Citric Acid with Polyglycol Esters

Esters of citric acid with polyglycol esters (b3), thus addition products of alkylene oxides with aliphatic carboxylic acids, which still have a free hydroxyl group on the end of the polyether chain, preferably agree with the formula (III),

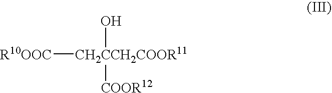

in which R¹⁰ is an (EO)ₙ₂(PO)ₘ₂(EO)ₚ₂R¹³ group, R¹¹ and R¹² are, independently of one another, R¹⁰ or hydrogen, R¹³ is an acyl radical having from 6 to 22, preferably from to 18, carbon atoms and 0 or from 1 to 3 double bonds, EO or PO is an ethylene oxide or propylene oxide unit and the numbers n2, m2 and p2 are, independently, numbers from 1 to 100, preferably from 2 to 10, the sum (n2+m2+p2) having to be other than 0. Use is preferably made, for the esterification, of addition products of 1 to 10 mol of ethylene oxide and 0 to 10 mol of propylene oxide, it being possible for the distribution to be random or blockwise, with industrial coconut oil fatty acids or tallow fatty acids.
Esters of Citric Acid with Ring-Opening Products of α-Olefin Epoxides

Esters of citric acid with α-olefin epoxides, thus alkanes which are substituted in the 1,2-positions with hydroxyl groups, preferably agree with the formula (IV),

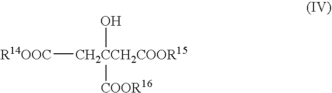

in which R¹⁴ is a CH₂CH(OH)R¹⁷ group, R¹⁵ and R¹⁶ are, independently of one another, R¹⁴ or hydrogen and R¹⁷ is an alkyl radical with from 4 to 22, preferably from 6 to 10, carbon atoms. Preference is given to the use of esters of citric acid with ring-opening products of 1-decene, 1-dodecene or 1-tetradecene epoxide with water.

### Preparations

In an additional preferred embodiment of the present invention, the preparations can exhibit the following composition:
(i) from 0 to 10% by weight, preferably from 1 to 5% by weight, of herbicides, insecticides and/or fungicides,
(ii) from 10 to 90% by weight, preferably from 50 to 80% by weight, of fatty substances and/or hydrocarbons, and
(iii) from 1 to 10% by weight, preferably from 2 to 8% by weight, of hydroxycarboxylic acid esters,
   with the proviso that the amounts are optionally made up to 100% by weight with additional auxiliaries and additives. The formulations can comprise nonionic emulsifiers as additional constituents, for example
(1) addition products of 2 to 120 mol of ethylene oxide and/or 0 to 75 mol of propylene oxide with linear fatty alcohols having from 8 to 22 carbon atoms, with fatty acids having from 8 to 22 carbon atoms, with alkylphenols having from 8 to 15 carbon atoms in the alkyl group and with fatty amines having from 6 to 22 carbon atoms;
(2) C_{12/18} fatty acid mono-, di- and triesters of addition products of 1 to 120 mol of ethylene oxide with glycerol or industrial oligoglycerols;
(3) Glycerol mono- and diesters and sorbitan mono- and diesters of saturated and unsaturated fatty acids having from 6 to 22 carbon atoms and the ethylene oxide addition products thereof;
(4) alkyl mono- and oligoglycosides having from 8 to 22 carbon atoms in the alkyl radical and the ethoxylated analogues thereof;
(5) addition products of 15 to 60 mol of ethylene oxide with castor oil and/or hydrogenated castor oil;
(6) polyol and in particular polyglycerol esters, such as, e.g., polyglycerol polyricinoleate or polyglycerol poly(12-hydroxystearate). Mixtures of compounds from several of these categories of materials are likewise suitable;
(7) addition products of 2 to 15 mol of ethylene oxide with castor oil and/or hydrogenated castor oil;
(8) partial esters based on linear, branched, unsaturated or saturated C_{6/22} fatty acids, ricinoleic acid and 12-hydroxystearic acid and glycerol, polyglycerol, pentaerythritol, dipenta-erythritol, sugar alcohols (e.g. sorbitol), alkyl glucosides (e.g., methyl glucoside, butyl glucoside or lauryl glucoside) and polyglucosides (e.g. cellulose);
(9) trialkyl phosphates and mono-, di- and/or tri(PEG-alkyl)phosphates;
(10) lanolin alcohols;
(11) polysiloxane-polyalkyl-polyether copolymers or corresponding derivatives;
(12) mixed esters of pentaerythritol, fatty acids, citric acid and fatty alcohols and/or mixed esters of fatty acids having from 6 to 22 carbon atoms, methylglucose and polyols, preferably glycerol,
(13) polyalkylene glycols, and
(14) glycerol carbonate.

The addition products of ethylene oxide and/or of propylene oxide with fatty alcohols, fatty acids, alkylphenols, glycerol mono- and diesters and sorbitan mono- and diesters of fatty acids or with castor oil are well known commercially available products. In this connection, homologous mixtures are concerned, the mean degree of alkoxylation of which corresponds to the ratio of the molar amounts of ethylene oxide and/or propylene oxide and substrate with which the addition reaction is carried out. C_{12/18} fatty acid mono- and diesters of addition products of ethylene oxide with glycerol are well known as refatting agents for cosmetic preparations.

In many cases, the joint use of anionic surfactants has proven to be worthwhile in the stabilizing of formulations and spray mixtures. Use is especially made here of the calcium salt of dodecylbenzenesulfonic acid (Ca-DDBS) and also soaps and amide soaps, since they have a sufficient solubility in oils.

### COMMERCIAL APPLICABILITY

As explained above, the hydroxycarboxylic acid esters are characterized in that they are oil-soluble, exhibit excellent emulsifying and dispersing properties for agrochemical active compounds and enhance the ability to penetrate thereof, as well as being completely biodegradable and entirely harmless toxicologically. An additional subject-matter of the present invention accordingly consists of their use, especially the use of citric acid esters, in the preparation of agrochemical formulations, in which they can be used, for example, in amounts of 1 to 10% by weight and preferably of 2 to 8% by weight.

### EXAMPLES

### Example 1

### Sprouting Spray Composition Based on Rapeseed Oil

| | |
|---|---|
| Rapeseed oil, refined | 80% by weight |
| Lamegin ® ZE 609 FL | 10% by weight |
| Citric acid ester based on sunflower | |
| oil fatty acid monoglyceride | |
| Agnique ® SBO 20 | 10% by weight |
| Soybean oil + 20 EO | |

### Example 2

### Sprouting Spray Composition Based on Rapeseed Oil Methyl Ester

| | |
|---|---|
| Rapeseed oil methyl ester | 80% by weight |
| Lamegin ® ZE 609 FL | 10% by weight |
| Citric acid ester based on sunflower | |
| oil fatty acid monoglyceride | |
| Agnique ® SBO 20 | 10% by weight |
| Soybean oil + 20 EO | |

### Example 3

### Sprouting Spray Composition Based on White Mineral Oil

| | |
|---|---|
| White mineral oil | 80% by weight |
| Plantapon ® LC7 | 10% by weight |
| C_{12/14} fatty alcohol + 7 EO citrate | |
| Agnique ® RSO 30 | 10% by weight |
| Rapeseed oil + 30 EO | |

### Example 4

### Herbicidal EC

| | |
|---|---|
| Trifluoralin in Solvesso ® 100 | 90% by weight |
| Lamegin ® ZE 609 FL | 5% by weight |
| Citric acid ester based on sunflower | |
| oil fatty acid monoglyceride | |
| Agnique ® RSO 30 | 5% by weight |
| Rapeseed oil + 30 EO | |

What is claimed is:

1. An agrochemical preparation, comprising:
(a) at least one agrochemically active compound, and
(b) at least one ester of a hydroxycarboxylic acid.

2. The preparation of claim 1 wherein component (a) is chosen from the group consisting of herbicides, insecticides, fungicides, fatty substances, hydrocarbons, and combinations thereof.

3. The preparation of claim 1 wherein component (b) comprises esters of hydroxycarboxylic acids chosen from the group consisting of lactic acid, malic acid, tartaric acid and citric acid.

4. The preparation of claim 3 wherein component (b) comprises at least one ester of citric acid with
(b1) partial glycerides,
(b2) polyglycol ethers,
(b3) polyglycol esters, or
(b4) ring-opening products of α-olefin epoxides.

5. The preparation of claim 4 wherein component (b1) comprises at least one citric acid ester of formula (I), 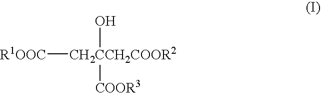
in which R¹ is a —CH₂—CH(OR⁴)CH₂OR⁵ group, R² and R³ are, independently, R¹ or hydrogen, R⁴ is an acyl group having from 6 to 22 carbon atoms and 0 to 3 double bonds, and R⁵ is R⁴ or hydrogen.

6. The preparation of claim 4 wherein component (b2) comprises at least one citric acid ester of formula (II), 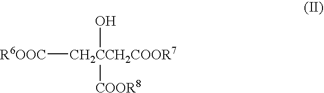
in which R⁶ is an (EO)ₙ₁(PO)ₘ₁(EO)ₚ₁R⁹ group, R⁷ and R⁸ are, independently, R⁶ or hydrogen, R⁹ is an alkyl or alkenyl group having from 6 to 22 carbon atoms, EO and PO represent an ethylene oxide and propylene oxide unit respectively, and n1, m1 and p1 are, independently, numbers from 1 to 100, provided that the sum (n1+m1+p1) is other than 0.

7. The preparation of claim 4 wherein component (b3) comprises at least one citric acid ester of formula (III), 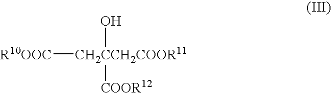
in which R¹⁰ is an (EO)ₙ₂(PO)ₘ₂(EO)ₚ₂R¹³ group, R¹¹ and R¹² are, independently, R¹⁰ or hydrogen, R¹³ is an acyl group having from 6 to 22 carbon atoms and 0 to 3 double bonds, EO and PO represent an ethylene oxide and propylene oxide unit respectively, and n2, m2 and p2 are, independently, numbers from 1 to 100, provided that the sum (n2+m2+p2) is other than 0.

8. The preparation of claim 4 wherein component (b4) comprises at least one citric acid ester of formula (IV), 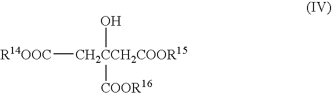
in which R¹⁴ is a CH₂CH(OH)R¹⁷ group, R¹⁵ and R¹⁶ are, independently, R¹⁴ or hydrogen, and R¹⁷ is an alkyl group having from 4 to 22 carbon atoms.

9. The preparation of claim 1 comprising:
(i) from 0 to 10% by weight of at least one herbicide, and/or insecticide and/or fungicide,
(ii) from 10 to 90% by weight of fatty substances and/or hydrocarbons, and
(iii) from 1 to 10% by weight of at least one hydroxycarboxylic acid ester,
with the proviso that the amounts total 100% by weight with optional auxiliaries and additives.

10. (canceled)

11. A method of preparing agrochemical formulations comprising adding at least one hydroxycarboxylic acid ester to at least one agrochemically active compound.
